(19) United States
(12) Patent Application Publication
(10) Pub. No.: US 2022/0220599 A1
(43) Pub. Date: Jul. 14, 2022

(54) Screen Cloth with Increased Wear Resistance and Method for Increasing the Wear Resistance of a Screen Cloth

(71) Applicant: Allgaier Werke GmbH, Uhingen (DE)

(72) Inventors: Mathias Trojosky, Kirchheim unter Teck (DE); Thomas Rupp, Bad Urach (DE); Matthias Lenz, Weinstadt (DE); Bernhard Wacker, Schwabisch Gmund (DE)

(21) Appl. No.: 17/574,639

(22) Filed: Jan. 13, 2022

(30) Foreign Application Priority Data
Jan. 13, 2021 (DE) 102021000118.4

(51) Int. Cl. C23C 8/22; D03D 9/00; C23C 8/26; C23C 8/32; B01D 39/12; B01D 29/01

(52) U.S. Cl. CPC C23C 8/22; D03D 9/00; C23C 8/26; C23C 8/32; B07B 1/4672; B01D 29/012; B01D 2239/10; B01D 2239/0478; B01D 2239/0613; B01D 39/12

(57) ABSTRACT

The invention relates to a method for increasing the wear resistance of a metal screen cloth made of wire, the method comprising treating a surface of a metal screen cloth by means of a thermochemical surface layer method for increasing the surface hardness and the wear resistance of metals, wherein the thermochemical surface layer method changes the structural conditions of the treated metal to a predetermined depth of penetration, wherein a hard surface layer is formed in the metal surface. A corresponding device and a screen cloth and a screen panel with increased wear resistance are also part of the invention.

This application claims the benefit of priority to German Patent Application No. 102021000118.4, entitled Screen Cloth with Increased Wear Resistance and Method for Increasing the Wear Resistance of a Screen Cloth, which was filed on Jan. 13, 2021. The disclosure of the prior application is incorporated by reference herein in its entirety.

The invention relates to a screen cloth with increased wear resistance and to a method for increasing the wear resistance of a screen cloth. Specifically, the invention relates to a method for treating a screen woven from metal wires for increasing the surface hardness and the wear resistance of the metal screen cloth.

Screening machines for the grading of bulk material or for the separation of particles from liquids are widely used in industrial practice and constitute a largely mature technology for the manufacturing of particle fractions of different particle size classes or for the sieving of coarse foreign matter from granular goods or from liquids. The machines and methods are used in large variety in almost any fields of industry.

Accordingly, in the past screening machines of very different designs were developed in accordance with different functional principles. For instance, one differentiates between vibration screening machines, so-called “sizers” with oblique screens, plane screening machines, or tumbler screening machines.

The screening machines used for the separation of goods of different particle sizes comprise screen decks which may predominantly consist of screen panels of metal or non-metal cloths, of wedge wire screens or of perforated metal sheets.

Depending on the size of the openings in the screen panels and/or the mesh width in cloths the bulk material is separated into fine material which falls through the openings and/or meshes, and coarse material which is transported on the screen panel to a coarse material outlet.

The screen decks or screen panels are either incorporated firmly in the housings of the screening machines and oscillated along therewith. Alternatively, the machine housings are stationary while only the screen decks or the screen panels themselves are moved by suitable mechanisms in the otherwise static machine housings.

All screening machines have in common that the mostly strained parts of the screening machines are the screen panels of the screen decks. They are subject to permanent wear both by the permanent oscillating movement with usually high acceleration and by the contact with the materials to be sieved. Depending on the strain, for instance, the screen cloths fail in that some or a plurality of wires of the cloths are rubbed through and consequently tear. Subsequently, the intended grading of the bulk material is no longer possible, and the screen decks with the screen panels or only the screen panels, i.e. for instance, the screen cloths, have to be exchanged before it is possible to continue with the production.

If woven screen panels are used, the screen cloths may either be manufactured of steel wire, as in most cases, or optionally, for instance, also of plastic wire. The selection of the material depends, for example, on the chemical, i.e. corrosive, or on the mechanical-abrasive strain by the bulk material to be treated. The degree of abrasive strain my inter alia be influenced by the hardness of the particles, their grain shape, or by the temporal amount flowing across or through the screen panel.

An additional corrosive or chemically conditioned strain of the screen cloths may occur if the screening material to be treated comprises a certain moisture and includes additionally salts or acids, for instance. Common high-grade steels or else available special steels usually withstand the chemical-corrosive strains occurring in screening processes sufficiently.

In the very predominant number of today's applications, high-grade steel is used for the manufacturing of screen cloths, for instance, from the material 1.4301 (AISI 304, V2A). In cases where higher strain of the cloths is expected due to mechanical wear, steel wire, for instance, from the material 1.4310 (AISI 301) may be used for the manufacturing of screen cloth. This material 1.4310 is a so-called spring-hard material which has higher hardness and hence improved wear resistance as compared to the material 1.4301, for instance.

An optional steel which is also hardwearing and from which steel wire for the manufacturing of screen cloths is manufactured is the material 1.0586 (C50D NIA steel) which is, however, a non-corrosion-resistant normal steel. For this reason, it can only be used in a limited manner for non-corrosive products and process conditions.

Since applications with increased wear occur less frequently, wire material of the above-mentioned wear-reduced steels is usually not produced and held available in stock in large amounts nor in all the wire gauges otherwise usual.

Consequently, when procuring these special materials for the manufacturing of specific screen cloths long delivery times or high costs will frequently occur.

In various applications, especially when screening coarse materials, screen cloths of a pre-coated steel wire are sporadically manufactured.

The coating of the wires has as an objective that the liability to wear of the screen cloths manufactured is also reduced. For the coating, largely independently of the basic material used for the screen cloths, suitable coating materials of plastics, such as rubber, synthetic resins, glass-like materials, etc. may be used. The coating of the wire for the manufacturing of the cloths is, however, also very complex, on the one hand, since wire of a length of many meters and/or kilometers has to be coated, the coating has to be hardened, and the wire, as a rule, has to be rolled up again before it can be used for the manufacturing of screen cloths. On the other hand, screen cloths manufactured of coated wire are frequency of minor dimensional accuracy, especially if the coating strength, due to the properties of the different coating systems, has to be relatively thick or cannot be observed exactly. This entails that very fine or very precise screen cloths with mostly small mesh widths usually are not and/or cannot be manufactured of coated wire material.

If local damages of such coatings in screening machines occur during the operation of the facility this may, as a consequence of the further use of pre-damaged screen panels, result in an accelerated wear due to local or large-scale detaching of the coatings, for example.

Alternatively, a metal screen cloth already manufactured can only be coated locally at the side of the cloth facing the solid matter to be treated, and only at the places of the wires of the cloth which are, due to the cloth structure and geometry and/or the curvature of the individual wires caused by the weaving, bulged out farthest and are thus particularly susceptible to wear.

This proceeding has the disadvantage that, with this kind of coating, good durability of the coating on the regions of the screen cloths which have been coated partially only is not always ensured and hence also the lifetime of the coated cloths is restricted if individual regions of the local coating should have been detached.

Furthermore, it is a disadvantage of the solution described that the locally applied, very small amounts of coating material get, in the case of detaching from the wire surfaces, into the product to be screened, either into the fine material or into the coarse material, and thus contaminate it.

Very fine screen cloths manufactured of a particularly thin wire material cannot be coated reliably and uniformly with high quality in the manner described since the viscosity of available coating materials, for instance, has an influence on the flow characteristics of the coating materials and can therefore not be used for finest screen cloths if high viscosity exists, for instance. In the case of fine mesh widths the gaps between the wires would, due to the use of highly viscous coating materials, become clogged easily and would make the screen cloth unusable. The applicability of such coatings is thus bounded below with respect to the mesh widths and the wire strengths of the screen cloths.

It is thus an object of the present invention to provide a method which eliminates and/or excludes the deficiencies and disadvantages of conventional methods. In accordance with the invention there is proposed a method which can be used in a simple and cost-efficient manner for the manufacturing and/or processing of screen cloths and/or screen panels having distinctly increased resistance especially to mechanical wear by abrasion. It is further an object of the present invention to provide screen cloths and/or screen panels having a distinctly increased resistance especially to mechanical wear by abrasion.

Moreover, it is intended to exclude production-technical and logistic disadvantages which originate from the fact that, for the case of the manufacturing of wire cloths of a pre-treated wire material, large amounts of wire of different wire strengths have to be treated and have to be held available subsequently.

The object in accordance with the invention is solved by the methods in accordance with claims 1 and 9, the device in accordance with claim 10, the screen cloth in accordance with claim 11, and the screen panel in accordance with claim 12. Further advantageous embodiments of the invention are indicated in the dependent claims 2-8.

In accordance with one aspect of the invention there is provided a method for increasing the wear resistance of a metal screen cloth made of wire, the method comprising: treating a surface of a metal screen cloth by means of a thermochemical surface layer method for increasing the surface hardness and the wear resistance of metals, wherein the thermochemical surface layer method changes the structural conditions of the treated metal to a predetermined depth of penetration, wherein a hard surface layer is formed in the metal surface.

Expediently, the metal screen cloth is woven from iron wires or steel wires.

Advantageously, the predetermined depth of penetration is at most one third of a diameter of the iron wires or steel wires from which the metal screen cloth is woven. This prevents the wire from being fully hardened and consequently becoming brittle. Thus, a non-hardened, viscous material core ensuring good fatigue strength of the wire remains in the interior of the wire. Due to the described proceeding of a hardening with limited depth it is moreover even possible to increase the viscosity of the remaining material core as compared to the previous state.

In accordance with a preferred embodiment the metal screen cloth is set to a spirally rolled state before the screen cloth is treated by means of the thermo-chemical surface layer method, wherein a plurality of spacers is arranged between individual cloth layers of the spirally rolled screen cloth so as to ensure that the individual cloth layers do not contact each other. Thus, it is ensured that no (partial) regions of the surfaces of the screen cloths are covered or shaded or contact each other, so that the intended treatment for the purpose of hardening by means of the thermochemical surface layer method would be obstructed locally.

In accordance with an alternative embodiment the metal screen cloth is clamped onto a frame before the screen cloth is treated by means of the thermochemical surface layer method.

Advantageously, carbonizing, nitriding, or nitrocarburizing is used as a thermochemical surface layer method, wherein in the case of carbonizing a process temperature of up to 480° C. is used and in the case of nitriding and nitrocarburizing a process temperature of up to 400° C. is used.

In accordance with a further aspect of the invention there is provided a method for manufacturing a screen panel with increased wear resistance, the method comprising:

treating a metal screen cloth with a method for increasing the wear resistance of a metal screen cloth according to any of the preceding claims; and

clamping the treated screen cloth onto a screen frame at a predetermined tension so as to obtain a screen panel with increased wear resistance.

If screen panels especially for round machines such as tumbler screening machines are manufactured, the screen cloths are, during the manufacturing of a screen deck, clamped onto the screen frame under a predetermined all-side tension, are glued or soldered with the screen frame there, and are kept under tension until the glue or the solder additive has hardened. This proceeding generates a screen panel whose screen cloth comprises an expediently high tension which is in turn of advantage and/or essential for a high-quality screening result.

Even if, in the above-describe methods, relatively low temperatures of e.g. up to approximately 400° C. or up to approximately 480° C., or even less, are used, it has to be expected that tensions in the material are relieved due to the temperature impact, i.e. here specifically tensions in the material by the pulling of the wire. Thus, screen cloths without a treatment in the afore-described manner would possibly be influenced more or less regularly or also irregularly and could therefore possibly go somewhat out of shape.

Hardening of the screen cloths prior to covering the screen frames to yield the screen panel is therefore particularly advantageous since tensions in the screen cloth are relieved by the thermal impact and it is thus avoided that the tension of the screen cloth on the screen panels produced decreases due to the temperature stress associated with hardening, as might be possible and/or is likely in the case of a subsequent hardening of screen panels that have already been clamped.

Due to the treating of the screen cloths prior to the covering of the screen frames to yield the screen panels a shape distortion in the screen cloth produced by the relieving of the tensions in the wire is unproblematic, on the one hand, and, on the other hand, it is even possible to achieve a more uniform screen covering, so that the tension of the screen cloth could be maintained for a longer time.

In accordance with a further aspect of the invention a device is provided which is adapted to perform the method according to any of claims 1-9.

In accordance with a further aspect of the invention a screen cloth is provided whose wear resistance was increased by making use of the method according to any of claims 1 to 8.

In accordance with a further aspect of the invention a screen panel with increased wear resistance is provided which was manufactured in accordance with the method of claim 9.

In the following, preferred embodiments of the present invention will be described by means of the following Figures.

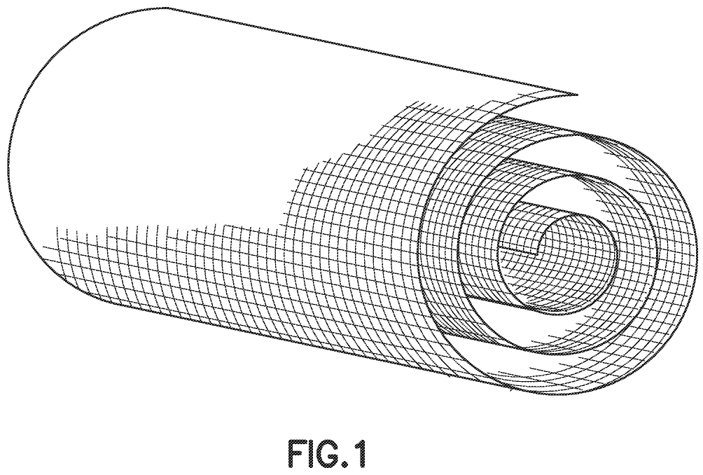

FIG. 1 shows an embodiment of a screen cloth rolled up for insertion in a treatment facility.

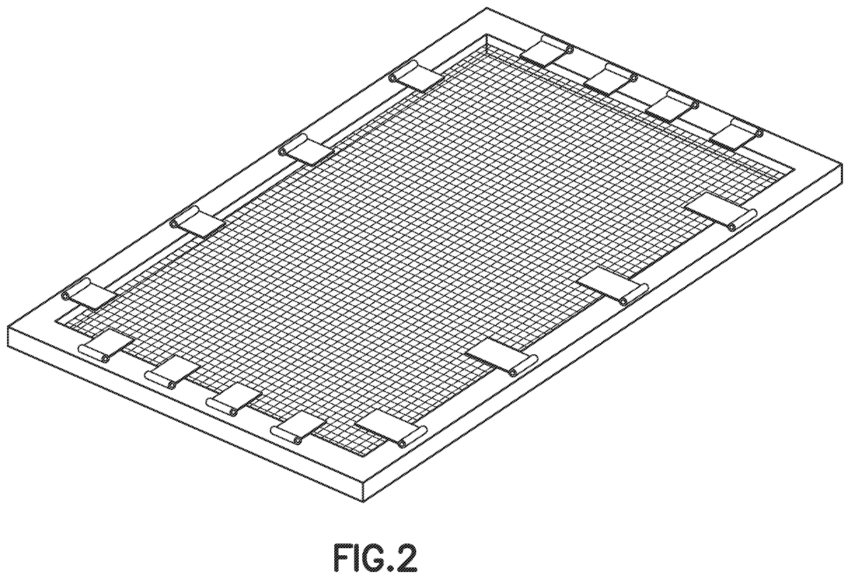

FIG. 2 shows an embodiment of a screen cloth clamped into a holding frame for treatment.

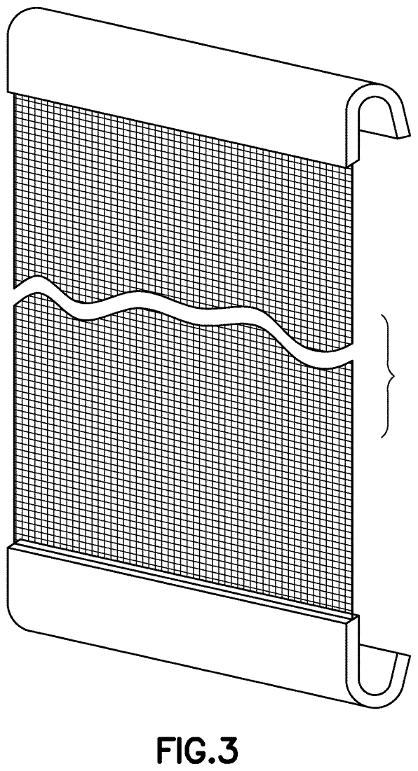

FIG. 3 shows an embodiment of a finished screen panel for a so-called sizer with retainers for clamping the screen panel in a screening machine, as it may be inserted suspended as a whole in a treatment facility for surface hardening.

For the manufacturing of the wear-proof screen panels, screen cloths of stainless steel are preferably used which are easily available in the market in large quantities and high variability from standard materials (especially usual stainless steels such as e.g. 1.4301). The materials of such easily available screen cloths usually do not have a particular resistance to mechanical wear, but are inexpensive, and screen cloths from this material are manufactured in very high variability. These screen cloths are in a usual manner cut such that they already have the sizes for the further processing, i.e. for instance, the covering of screen frames.

Depending on the sizes of available treatment facilities for increasing the wear resistance by surface hardening, which will be described in the following, the screen cloths cut this manner are either rolled up spirally and supported, by suitable spacers preferably at the outer edges of the cuts, such that the individual cloth layers do not contact each other. The latter is necessary to ensure that no regions and/or partial regions of the surfaces of the screen cloths are covered or shaded or contact each other, so that the intended treatment for the purpose of hardening in a tempered gas atmosphere would be obstructed locally. FIG. 1 shows an embodiment of a screen cloth rolled spirally for insertion in a treatment facility, wherein the above-described spacers are not illustrated.

Optionally, the cut cloth may also be clamped in a preferably frame-shaped, metal device such that it can be inserted flatly in the treatment chamber and need not be rolled. FIG. 2 shows a screen cloth clamped in a holding frame for treatment. This method may be used preferably if screen cloths of smaller sizes are to be treated and/or if treatment facilities of particularly large dimensions are available and there is thus no need for rolling up the cloth.

In a further variant the screen cloth already provided with retainers for a finished screen panel may be inserted in the treatment chamber along with the retainers as a finished screen panel. This is possible if the entire screen panel is, for instance, made of metal materials which withstand the thermal and chemical strains in the treatment facility for increasing the wear resistance, as it is, for instance, the case with screen panels for so-called sizers. Such screen panels are not pre-clamped on a frame, but are only clamped in the screening machine during installation. FIG. 3 shows a finished screen panel for a sizer with retainers for clamping the screen panel in a screening machine, as it may be inserted suspended as a whole in a treatment facility for surface hardening. In the case of such screen panels the screen cloths are, at the upper and lower edges, grouted with metal sheets guided along the contour of the screen panel, so that no glues have to be used which would, for instance, be temperature-resistant in a restricted manner only.

Specialized manufacturing plants have treatment chambers available which enable such proceeding also for screen panels having a longitudinal and/or width extension of up to 3.5 meters, for instance.

In the treatment chamber for increasing the wear resistance the screen cloth or the screen panels prepared in this manner are, by a thermal process in the presence of a defined atmosphere of different gases and at a predetermined pressure and for a likewise defined period of time, subject to conditions which result in that gases diffuse into the surface of the metal screen cloths and consequently the structure in the near-surface layers of the screen cloths changes.

Suitable processes for increasing the wear resistance of screen cloths are, for instance, carbonizing, which is also referred to as carburizing, nitriding, which is also referred to as nitrogenizing, or nitrocarburizing.

Carbonizing refers to a method in which carbon diffuses into metals, especially steel. For this purpose, in the case of conventional methods, e.g. iron or steel is heated in a carbonaceous environment to temperatures of up to 850° C. or more. Modern methods use process temperatures of up to approximately 480° C. The carbon and/or the carbonaceous compounds may be added in solid, liquid, or gaseous form.

For the treatment of especially very fine screen cloths it is advantageous to provide carbon in the gaseous phase so as to achieve a uniform treatment of the surface. Preferably, a hydrocarbon such as, for instance, methane or propane, is added as an enrichment gas in a controlled manner to a suitable carrier gas so as to generate a suitable hydrocarbon-enriched atmosphere. The process and/or treatment duration during carbonizing may, for instance, be up to approximately 48 hours.

By means of carbonizing it is possible to specifically produce many metal carbides such as, for instance, tungsten carbide or tantalum carbide, whereby a hard surface layer is produced in the steel surface. Usual penetration depths during carbonizing are approximately 25 to 30 μm, wherein, however, the depth of penetration may by influenced by the parameters set in the process, especially process time and process temperature. Thus, it can be ensured that the steel is not through-hardened and thus a hardened wire, for instance, becomes completely brittle, but that a non-hardened, i.e. comparatively viscous and soft core is maintained which provides for the necessary strength of the steel.

Nitriding (nitrogenizing) refers to a method in which nitrogen diffuses into metals, especially steel. Due to the diffusion of nitrogen a layer is formed in the material surface which has, as a rule, two zones, a connection layer with a thickness of approximately 2 μm to 20 μm which is very hard due to the formation of metal nitrides, especially iron nitrides, and an underlying diffusion zone in which nitrogen is embedded to a particular depth in the ferritic metal matrix. With a sufficiently high component temperature and a correspondingly long treatment time a penetration depth of down to approximately 0.8 mm is possible for particular steels.

Additionally, the nitrogen embedded in a solid solution results in an increase of the fatigue strength which is particularly advantageous for permanently moved and/or vibrating screens and screen cloths.

In order to increase the corrosion protection of these layers it is possible to oxidize the connection layer, for instance, by a vapor impact which makes the iron portions corrode and thus forms an oxide layer.

A differentiation is made between gas nitriding (e.g. in an ammonium atmosphere at slight excess pressure), bath nitriding (in salt baths), and plasma nitriding (by means of ionized gas).

For the treatment of especially very fine screen cloths it is advantageous to provide nitrogen in the gaseous phase so as to achieve a uniform treatment of the surface. Advantageously, ammonium is supplied in a controlled manner so as to obtain the desired ammonium atmosphere. Gas nitriding is conventionally performed at temperatures of up to approximately 520° C. Modern methods make use of process temperatures of up to approximately 400° C. The process and/or treatment duration during nitriding may, for instance, be up to approximately 24 hours.

Plasma nitriding is particularly advantageous since here process temperatures that have been decreased again may be used. The method operates with a nitrogen hydrogen gas mixture as a nitriding medium which is ionized in a vacuum furnace at a negative pressure of approximately 50 Pa to 600 Pa, for instance, by means of a strong-current glow discharge. Due to the high energetic effect of the plasma the operating temperature during plasma nitriding can be decreased substantially as compared to gas nitriding, so that this method may also be used with materials and components which are sensitive to shape distortion. The typical operational range during plasma nitriding of iron alloys lies between approximately 350° C. and 600° C.

The work piece to be treated acts as a cathode in an evacuated container, the container wall as an anode. A nitrogenous gas is supplied in small quantities. After applying a high voltage the nitrogen atoms in the vicinity of the cathode are ionized. The positively charged nitrogen ions are accelerated toward the work piece, impinge there at high kinetic energy, and are embedded in the surface. The impinging energy is partially converted to heat. Depending on the process control a pure diffusion layer or, if the solubility limit is exceeded, additionally a connection layer of a thickness of approximately 2 μm to 20 μm is built up. While the achievable surface hardness is determined substantially by the type of steel, the thicknesses of the layers produced are additionally influenced by the treatment temperature, the treatment times, and the nitrogen offer in the process gas.

Nitrocarburizing is a thermochemical method for enriching the surface layer of a work piece with nitrogen and carbon. So, the nitriding layer consisting of a connection layer and a diffusion layer already described above is produced on the outer surface of the workpiece treated, and additionally carbon is embedded in the work piece surface, wherein the depth of penetration of the carbon is somewhat higher than that of the nitrogen. Due to the nitrogen especially the chromium contained in the steel is converted to particularly hard chromium nitrides near the surface. A connection layer produced by nitrocarburizing is very wear and corrosion resistant, but less brittle than a connection layer produced by nitriding. Usual depths of penetration with nitrocarburizing are approximately 14 μm to 18 μm.

In the case of nitrocarburizing a difference is made between gas nitrocarburizing and plasma nitrocarburizing. The proceeding is the same as with nitriding, apart from the gas atmosphere used which additionally contains a carbonaceous gas.

The process temperatures used with nitrocarburizing correspond substantially to the process temperatures used with nitriding, i.e. up to approximately 400° C. with gas nitrocarburizing and between approximately 350° C. and 600° C. with plasma nitrocarburizing. Also the process and/or treatment duration with nitrocarburizing corresponds substantially to the process and/or treatment duration with nitriding, i.e. for instance, up to approximately 24 hours.

The structural changes cause the forming of a substantially harder and hence more wear resistant surface as compared to the untreated material, wherein already a very small depth of penetration of the structural change of some few hundredths or tenths of millimeters causes a very significant hardness increase of the metal surfaces and hence a particularly good wear protection.

It is not essential and not of disadvantage that, when making use of the above-mentioned methods for the treatment of finished woven screen cloths, local exposures at the individual wires occur at the contact faces between the weft and warp threads of the screen cloths. These places which are not reached during the hardening of the screen cloths are, in the built-in state of the screen cloths in the screen panels and/or during the use in screening machines, not subject to the wearing effect of the bulk material to be screened and are consequently not subject to wear, either. Rather, the omitted treatment of the contact places between weft and warp threads may, exactly at these possibly critical bending places of the individual wires, result in additional strength of the wires and/or cloths since these places are not brittle since they are not hardened.

All the other surfaces of the wires and screen cloths which are freely accessible for the gases in the treatment facility for hardening and which are also specifically subject to the abrasive strain by the products to be screened are treated very uniformly and are consequently also hardened very efficiently.

The achievable depths of penetration of the hardening method in the surfaces of the wires of the wire cloth are, depending on the specific method and the process parameters used and/or set, such as e.g. the process temperature or the process duration, between 10 μm and 200 μm.

It is clear that particularly thin wires which usually very fine-meshed screen cloths are made from (e.g. 35 μm wire for the manufacturing of screens with 60 μm mesh width) should expediently only be hardened with lower depths of penetration since a depth of penetration of 30 μm all-around would through-harden the wire completely, so that in turn a possibly too high brittleness of the wire would be produced, with the danger that the wire will break more likely during the oscillating strain in a screening machine.

It is rather desired to only achieve a depth of penetration of approximately ⅓ of the wire diameter. In the case of a wire diameter of 30 μm a depth of penetration of approximately 10 μm would, for instance, be advantageous. Thus, a non-hardened, viscous material core remains in the interior of the wire which ensures good fatigue strength of the wire and which produces, at least with some of the hardening methods mentioned, even additional viscosity of the material core as compared to the prior state of the wire material.

This small depth of penetration of the hardening of e.g. approximately 10 μm is also completely sufficient in the case of thin wires since, with fine screen cloths of thin wires, only products with small particle size, small particle mass, and consequently less strong abrasion influence on the individual wires are screened.

A deeper depth of penetration of e.g. up to 30 μm is, however, no problem and even desired in the case of stronger wires for coarser screen cloths with larger mesh widths. In the case of a wire strength of 600 μm or 1 mm, for instance, an all-side depth of penetration of e.g. 30 μm leaves a viscous wire core of 540 μm or 940 μm.

The achievable depth of penetration of the respective hardening method in the surfaces of the wires of the wire cloth depends on the type of hardening method used (e.g. carbonizing, nitriding or nitrocarburizing) and may additionally be varied and/or adjusted by the choice of suitable process parameters such as e.g. the process temperature or the process time.

The method of the surface hardening of screen cloths for increasing the wear resistance in accordance with the invention has, apart from the advantages already described, the further advantage that it may also be used for the treatment of fine and very fine screen cloths of thin and very thin wire material. The use of gases for the treatment of the steel surfaces enables the advancing of the gases and hence the hardening of even smallest and narrowest regions of the screen cloths as they naturally occur by the weaving of wire material.

The hardening does not result in any modifications of the wire strengths, so that the dimensional accuracy of the screen cloth and/or screen panel produced also exists after hardening.

The corrosion resistance of steels in general and of stainless steels in particular is not influenced by the methods of nitriding and especially by the method of carbonizing. The method of carbonizing rather even increases the corrosion resistance of steels.

Thus, as a further advantage of the described method of the hardening of screen cloths almost any available stainless steel may be used for screen manufacturing depending on the concrete corrosion strain of the respective material to be screened and/or depending on the specific process conditions and the grain fractions to be produced.

Moreover, by the method of nitriding the viscosity and elasticity of the steel materials in the interior of the wires used for screen manufacturing and hence the tensile strength of these wires is increased, which is especially advantageous under the aspect that screen cloths are, apart from the abrasive strain due to wear on the part of the product, also subject to strong strain due to the permanent variations in stress as a consequence of the vibrations.

If screen cloths are manufactured in particular for round machines such as tumble screening machines, the screen cloths are, during the manufacturing of a screen deck, clamped on the screen frame under a predetermined all-side tension, are glued or soldered with the screen frame there, and are kept under tension until the glue or the solder additive has hardened. This proceeding generates a screen panel whose screen cloth comprises an expediently high tension which is in turn of advantage and/or essential for a high-quality screening result.

Even if, with the above-described methods, relatively low temperatures of up to approximately 400° C. or up to approximately 480° C., or even less, are used, it has to be expected that tensions in the material are relieved due to the temperature impact, i.e. here specifically tensions in the material due to the pulling of the wire. Thus, the screen cloths would possibly be influenced more or less regularly or also irregularly and could therefore possibly go somewhat out of shape.

Hardening of the screen cloths and as a consequence thereof a relief of tensions in the wires of the screen cloth prior to the covering of the screen frames to yield the screen panel is therefore particularly advantageous since it is avoided that the tension of the screen cloth on the screen panels (screens) produced decreases due to the temperature stress associated with the hardening, as might be possible and/or is likely in the case of a hardening of screen panels that have already been clamped or else by the use of untreated screen cloths.

Due to the treating of the screen cloths prior to the covering of the screen frames to yield the screen panels a shape distortion in the screen cloth produced by the relieving of the tensions in the wire is unproblematic, on the one hand, and, on the other hand, it is even possible to achieve a more uniform screen covering, so that the tension of the screen cloth could be maintained for a longer time.

It has to be emphasized as particularly advantageous that the known general proceeding for the manufacturing of screen panels from screen cloths and possibly screen frames may be maintained. However, as a difference from the known proceeding, the screen cloths are not manufactured from wear-resistant wire material that was already treated before for achieving better wear resistance. Instead, conventionally manufactured, commercial screen cloths which are, in their variety, available as standard in the market are treated. This may take place in exactly the number and size required for the manufacturing of the specific desired wear-protected screen panels depending on the process and on the customer.

Thus, with the method in accordance with the invention it is possible to manufacture screens and/or screen panels in the required quantity and quality in a simple and inexpensive manner, wherein the screens and/or screen panels have a particularly high wear resistance due to the hardening of the surfaces of the wires of the screen cloth.

1. A method for increasing the wear resistance of a metal screen cloth made of wire, the method comprising:
treating a surface of a metal screen cloth by means of a thermochemical surface layer method for increasing the surface hardness and the wear resistance of metals, wherein the thermochemical surface layer method changes the structural conditions of the treated metal to a predetermined depth of penetration, wherein a hard surface layer is formed in the metal surface.

2. The method for increasing the wear resistance of a metal screen cloth according to claim 1, wherein the metal screen cloth is woven from iron wires or steel wires.

3. The method for increasing the wear resistance of a metal screen cloth according to claim 2, wherein the predetermined depth of penetration is at most one third of a diameter of the iron wires or steel wires from which the metal screen cloth is woven.

4. The method for increasing the wear resistance of a metal screen cloth according to claim 1, wherein the metal screen cloth is set in a spirally rolled state before the screen cloth is treated by means of the thermochemical surface layer method.

5. The method for increasing the wear resistance of a metal screen cloth according to claim 4, wherein a plurality of spacers is arranged between individual cloth layers of the spirally rolled screen cloth before the screen cloth is treated by means of the thermochemical surface layer method so as to ensure that the individual cloth layers do not contact each other.

6. The method for increasing the wear resistance of a metal screen cloth according to claim 1, wherein the metal screen cloth is clamped onto a frame before the screen cloth is treated by means of the thermochemical surface layer method.

7. The method for increasing the wear resistance of a metal screen cloth according to claim 1, wherein one of the following thermochemical surface layer methods is used for treating the surface of the metal screen cloth:
carbonizing, nitriding, or nitrocarburizing.

8. The method for increasing the wear resistance of a metal screen cloth according to claim 7, wherein a process temperature of up to 480° C. is used for carbonizing, and a process temperature of up to 400° C. is used for nitriding and nitrocarburizing.

9. A device adapted to perform the method according to claim 1.

10. A method for manufacturing a screen panel with increased wear resistance, the method comprising:
treating a metal screen cloth with a method for increasing the wear resistance of a metal screen cloth according to any of the preceding claims; and
clamping the treated screen cloth onto a screen frame at a predetermined tension so as to obtain a screen panel with increased wear resistance.

11. A device adapted to perform the method according to claim 10.

12. A screen cloth whose wear resistance was increased by making use of the method according to claim 1.

13. A screen panel with increased wear resistance which was manufactured in accordance with the method of claim 9.
